(19) United States
(12) Patent Application Publication
(10) Pub. No.: US 2001/0021091 A1
(43) Pub. Date: Sep. 13, 2001

(54) Protective circuit against persistent overvoltage in an electronic unit

(75) Inventor: Rolf Weichler, Weeze (DE)

Correspondence Address: PERMAN & GREEN, 425 POST ROAD, FAIRFIELD, CT, 06430, US

(73) Assignee: Nokia Mobile Phones Ltd.

(21) Appl. No.: 09/751,894

(22) Filed: Dec. 28, 2000

(30) Foreign Application Priority Data
Dec. 31, 1999 (DE) 19964097.1

(51) Int. Cl. H02H 3/20

(52) U.S. Cl. 361/58; 361/91.1

(57) ABSTRACT

A protective circuit for an electronic unit (EU) for protection against persistent overvoltage in an automobile, located between the network connections (DC_{IN}, GND₁) of an on-board voltage network with an on-board voltage (V_{B}), and the operating voltage connections (DC_{OUT}, GND₂) of the electronic unit (EU). The protective circuit comprises an overvoltage indicator (OVI) which is connected to the network connections (DC_{IN}, GND₁) of the on-board voltage network, and triggers a switching signal (S_{O}) when a threshold value of the on-board voltage (V_{B}) has been exceeded, a switch (SW) with input electrodes (S, G) which can be activated by the switching signal (SO), and a voltage limiter (VL) to limit short-term overvoltage. According to the invention the switch (SW) lies in series with the electronic unit (EU) but before the voltage limiter (VL), and is controlled via a time integrator (INT) by the switching signal (S_{O}) of the overvoltage indicator (OVI) From the temporal course of the switching signal (S_{O}), the time integrator (INT) forms an integration voltage (V_{I}) which closes the switch (SW) as long as the integration voltage (V_{I}) lies within a specified range of values. The integration voltage (V_{I}) in the range of values indicates that there is no danger for the electric unit (EU) and the voltage limiter (VL) from additionally supplied electric power.

### DESCRIPTION

The invention concerns a protective circuit for an electronic unit for protection against persistent overvoltage in the on-board voltage network of an automobile. The electronic unit in particular is a telematic unit, a position finding device or an on-board telephone in an automobile, which as a rule always operates in parallel with the engine and is supplied by the on-board voltage network. A persistent overvoltage in the sense of this document is a voltage increase for a period of time which is a multiple of the usual voltage pulse durations in the on-board voltage network, where the on-board voltage is significantly higher than the charging voltage of a charged car battery. The onboard voltage network has considerable excess power in this condition which can overheat and destroy the connected unit.

The power of electrical installation in an automobile is usually supplied by an on-board generator. For example to start the engine or cover a temporary high power need, the generator has back-up electric power in a power storage device in the form of a starter battery.

If inductive electrical consumers such as fan motors or seat controls are shut-off from the on-board voltage network during vehicle operation, this causes voltage pulses which often increase the normal on-board voltage by a multiple. Although these short voltage pulses only contain a small excess of power, they can considerably damage the functions of electronic units in automobiles. An effective measure against low power short voltage pulses is to install a voltage limiter as a shunt component in parallel with the operating voltage connections. In the simplest case a voltage limiter can be a Z diode, a suppressor diode or another bipolar device with a voltage-dependent curve. Complex electronic solutions with semiconductor switches such as transistors or thyristors, which are controlled by a voltage sensing unit, are also known. The publication DE 197 10 073 A1 (=WO 98/40965) can be cited as an example of the known solutions.

A persistent on-board overvoltage is produced for example when a connection from the generator to the battery is defective. If a cable from the generator to the battery is broken, or a battery connection is corroded and the control device malfunctions, the on-board generator can produce excess power for a long time. Because of on-board overvoltage, this power can endanger sensitive connected electronic parts through self-heating.

Another danger for the cited parts exists when a new vehicle is delivered. For safety reasons a vehicle manufacturer delivers new vehicles to the seller without a connected and charged battery. To move the vehicles under their own power during the delivery, the vehicle engines are started with an outside battery. To simplify the starting process, a battery with twice the nominal voltage of the onboard voltage network is frequently used. Since the starting process of vehicles which have not operated for several weeks, for example after maritime transportation, can take on the order of minutes, during that time the onboard voltage network experiences an overvoltage with a considerable excess of power. During such time the overvoltage can heat a connected electronic unit to an unallowable degree and thereby cause permanent damage. To prevent this it is known from DE 197 10 073 A1 to use the voltage sensing unit to adjust the production of power in the on-board generator downward for the duration of the persistent overvoltage.

A disadvantage of this solution however is that an electronic unit which represents an optional accessory for an automobile is unable to control the on-board generator. Since the voltage limiter is furthermore in parallel with the operating voltage connections, it must convert relatively much power into heat and must therefore have a large volume to dissipate the heat. The electronic unit can only provide this with much difficulty. In addition the circuit also needs its own operating power when the on-board voltage is within the specified tolerance range. This is undesirable with an electronic accessory because it can lead to the uncontrolled discharge of the battery.

An electronic unit such as a telematic unit or a car telephone require a considerable amount of electric power. For example to generate an HF output of 8 Watts for the transmitter and several Watts of sound output for the audio reproduction of the intercom station, the on-board voltage network must deliver more than 15 Watts of electric power. The electric unit already needs an operating current of at least 1.3 A for a nominal operating voltage U_{B}=12 V. In addition, the low loss operation of the output stages and the desired output power at the usual load impedances require that the normal on-board voltage always has the full voltage available, if possible. Furthermore the circuit itself should not require much electric power to effectively protect the circuit against persistent overvoltage, to only minimally reduce the operating voltage of the electronic unit, and only minimally increase the resistance of the onboard voltage source. Conventional voltage stabilizers with a series actuator are thus eliminated from achieving this object, particularly because of the high internal voltage losses.

Starting with that, the object of the invention is to create a protective circuit which reliably protects an electronic unit of the on-board voltage network in an automobile against both persistent overvoltage and short-term overvoltage peaks. The circuit must avoid the drawbacks of known solutions and be integratable in the electronic unit with minimum idle current, low volume effort and without additional measures for dissipating heat energy. The object is achieved with the features of claim 1. The dependent claims refer to special configurations of the invention.

The invention starts with a protective circuit which is located between the on-board voltage network of the automobile and the operating voltage connections of the electronic unit. The protective circuit contains an overvoltage indicator which is connected to the on-board voltage network, a switch and a voltage limiter located at the operating voltage connections of the electronic unit.

The switch of the protective circuit of the invention is in series with the electronic unit but before the voltage limiter, and is connected to the overvoltage indicator via a time integrator. If the on-board voltage exceeds a specified threshold value, the overvoltage indicator generates a switching signal for the duration of the excess. The time integrator forms an integration voltage from the time course of the switching signal. It closes the switch and connects the operating voltage to the on-board voltage network when:

the on-board voltage is under the specified threshold value, or

when the on-board voltage exceeds the specified threshold value for a predetermined period of time only, and the frequency of the excesses, as integrated over time, is so small that the integration voltage stays within a specified range of values which indicates that there is no danger for the voltage limiter and/or the electronic unit from additionally supplied electric power.

However, if the on-board voltage is exceeded for a long time and/or often, so that there is danger of overheating the downstream circuit, the integration voltage leaves the specified range of values and opens the switch to separate the electronic unit from the on-board voltage network. The switch then remains open as long as the onboard voltage is above the specified threshold value. The specified range of values comprises all the integration voltage values at which the switch is reliably open.

If in a special configuration of the invention a switching signal is infrequent or missing, the integrator keeps the switch conductive by means of a control voltage which is stored as a charging voltage in an integrating capacitor. If the threshold value in the on-board voltage network is being exceeded, the overvoltage indicator discharges the integrating capacitor at a discharging time constant T_{D}=R6 C_{I}, so that after a discharge period specified by the time constant T_{D}, the switch leaves the specified range of values by operating under a minimum integration voltage, which separates the electronic unit from the on-board voltage network. However if the switching signal expires before the end of the specified discharge time, the on-board voltage network charges the integrating capacitor at a charging time constant T_{C}=(R5+R6) C_{I}, so that the integrating capacitor supplies an integration voltage for an overvoltage within a predetermined duration and low frequency, which is above the minimum value and thus allows the switch to remain closed.

The known voltage limiter is located behind the switch and parallel to the operating voltage connections of the electronic unit; it limits the on-board voltage for the electronic unit to a specified value during the time before the switch is activated, and deflects short-term overvoltage peaks to ground. To ensure a reliable activation of the overvoltage indicator, the limit value at which the voltage limiter holds the on-board voltage during activation caused by overvoltage, is chosen so that it is above the threshold value for the overvoltage indicator.

Both the overvoltage indicator and the voltage limiter are designed so that they require no, or only a small amount of electric power before they reach the threshold value.

The invention will explained in the following by means of an embodiment and drawings which respectively show:

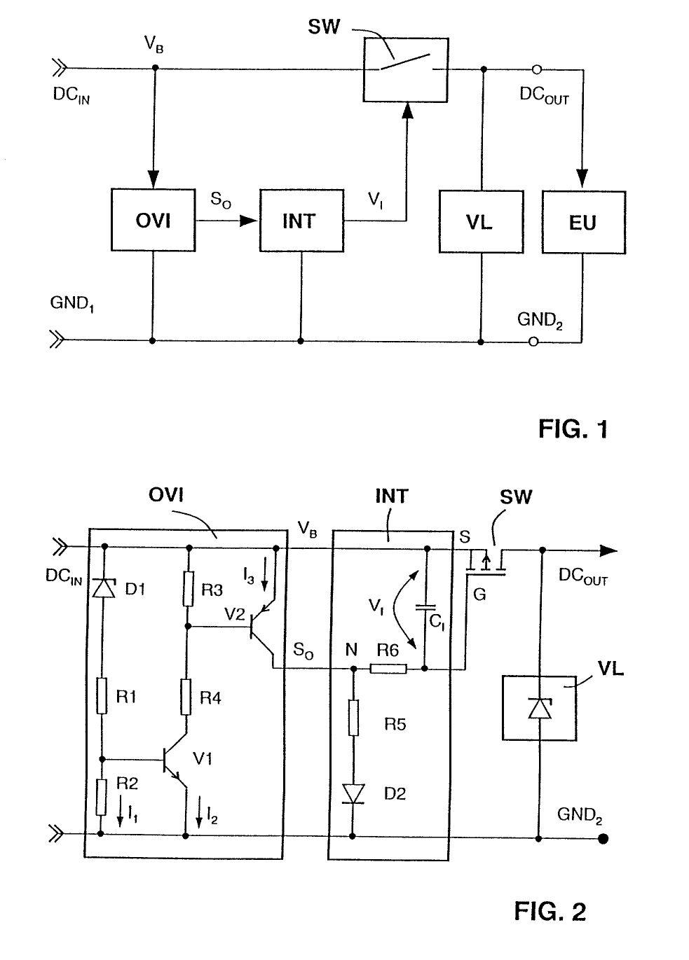

FIG. 1 a block circuit diagram of the protective circuit according to the invention;

FIG. 2 a special, detailed configuration of the invention.

In an automobile the protective circuit shown in FIG. 1 is located between network connections DC_{IN} and GND₁ of a not illustrated on-board voltage network with an on-board voltage V_{B} and operating voltage connections DC_{OUT} and GND₂ of an electronic unit UE (sic). The protective circuit contains an overvoltage indicator OVI which is connected to the onboard voltage network via connections DC_{IN} and GND₁, and triggers a switching signal S_{O} when a threshold value for the on-board voltage V_{B} has been exceeded. The overvoltage indicator OVI generates the switching signal S_{O} as long as the on-board voltage V_{B} is above the threshold value. The protective circuit also contains a switch SW with input electrodes S and G, which can be activated by the switching signal S_{O}, and a voltage limiter VL which limits short-term overvoltages for the electronic unit.

In accordance with the invention the switch SW is in series with the electronic unit EU, and the voltage limiter VL is located between the switch SW and network operating connections DC_{OUT} and GND₂. Through a time integrator INT the switch SW is connected to the switching signal SO output of the overvoltage indicator OVI. The time integrator INT forms an integration voltage V_{I} from the temporal course of the switching signal S_{O}. In a special case the integration voltage V_{I} corresponds to the duration and frequency at which the on-board voltage network previously conducted overvoltage that was above the threshold value. The momentary value of the integration voltage V_{I} therefore does not correspond directly to the on-board voltage V_{B} value.

The time integrator INT is designed so that the integration voltage V_{I} is within a specified range of values when the electric power supplied to the voltage limiter VL is so low that no damage from overheating can be expected. The switch SW then remains closed even though additional power from overvoltage is available, for example due to turned-off electrical consumer devices. The voltage limiter VL limits this short-term overvoltage without any problems and without any unusual self-heating. In this way the above described short-term overvoltage peaks, which often occur in automobiles, can be eliminated without interrupting the function of the electronic unit EU.

However, if the duration and/or the frequency of the threshold value excesses in the on-board voltage network are very drastic, the integration voltage V_{I} lies outside of the specified range of values and the time integrator INT opens the switch SW in order to separate the electronic unit EU and the voltage limiter VL from the on-board voltage network. In that case the integration voltage V_{I} indicates an energy-rich overvoltage in the voltage limiter VL and/or the electronic unit EU, which exceeds a specified quantity and can cause damage due to overheating.

The solution of the invention has therefore the advantage that the protective circuit can be designed with a voltage limiter VL which only needs to convert small electrical outputs. Such a circuit can be realized with inexpensive components for low output, and can be integrated at low cost and with a small volume into the electronic unit EU. Yet the solution offers a high degree of safety and improvement since the protective circuit only separates the electronic unit EU from the on-board network during extremely long overvoltage phases.

As shown in FIG. 2, the switch SW of the present example is an enrichment-type power FET, which becomes conductive by means of an input voltage. The input electrode S via the network connection DCIN, and the input electrode G via an impedance chain and the resistors R5 and R6, are connected to the ground electrode GND₁ of the network connection. In addition an integrating capacitor C_{I} is connected to the input electrodes G and S of switch SW. The integration capacitor C_{I} and the resistors R5 and R6 with a tap N form the time integrator INT. The resistors R5 and R6 charge the integrating capacitor C_{I} to a maximum integration voltage V_{IMAX} which corresponds to the on-board voltage V_{B}. The specified range of values for the integration voltage V_{I} at which the power FET is opened lies between the maximum integration voltage V_{IMAX} and the minimum value of the integration voltage V_{IMIN}.

The tap N is connected to the switching signal S_{O} output of overvoltage indicator OVI, which in the present example is a switching amplifier with amplification stages and a signal input. The signal input is connected to the network connection DC_{IN} via a threshold value element D1 with voltage-dependent conductivity. The overvoltage indicator OVI is designed as a d.c. voltage amplifier with complementary transistors V1 and V2, so that with an onboard voltage V_{B} which is under the specified threshold value, both transistors are cut off and the d.c. current branches I₂ and I₃ only conduct the cut-off currents of transistors V1 and V2. In the present example the threshold value element D1 is a Zener diode which adjusts the threshold value for the on-board voltage V_{B} by means of its Zener voltage, and also cuts off at an on-board voltage V_{B} which is under the specified threshold value. The d.c. current branches I₁, I₂ and I₃ thus conduct exclusively cutoff currents of the active components D1, V1, V2. The whole protective circuit therefore only needs a negligible operating current and places no burden on the battery until the on-board voltage VB exceeds the threshold value.

The threshold value element D1 and the transistors V1 and V2 become conductive when the on-board voltage V_{B} exceeds the threshold value. Through resistor R6, the transistor V2 discharges the integrating capacitor C_{I} in the time integrator INT at a discharge time constant T_{D}=R6 C1. Since transistor V2 connects the tap N to input electrode S, the resistor R5 cannot recharge the integrating capacitor C_{I} during that time. Only when the on-board voltage V_{B} drops below the threshold value, and the threshold value element D1 and thus transistors V1 and V2 are cut off, can the integrating capacitor C_{I} be recharged via the series connection of resistors R5 and R6.

The circuit in FIG. 2 shows a special configuration of the invention. The overvoltage indicator OVI can also be designed as a single stage d.c. voltage amplifier. In that case transistor Vi and the resistors R1 and R2 are omitted. The threshold value element D1 then replaces the collector-emitter path of transistor V2. Furthermore resistors R5 and R6 can be replaced by current sources.

In addition to resistors RS and R6, the impedance chain contains a switching diode. It is polarized to avoid discharging the integrating capacitor C_{I} when the on-board voltage V_{B} is temporarily much under the normal voltage range, for example when starting the vehicle with an almost discharged battery. The integration voltage V_{I} keeps the switch SW closed during this time as well.

1. A protective circuit for an electronic unit (EU) for protection against persistent overvoltage, where the circuit is located between network connections (DC_{IN}, GND₁) in an onboard voltage network with an on-board voltage (V_{B}) of an automobile, and operating voltage connections (DC_{OUT}, GND₂) of the electronic unit (UE sic), and comprises the following components:
an overvoltage indicator (OVI) which is located in the network connections (DC_{IN}, GND₁) of the on-board voltage network, and triggers a switching signal (S_{O}) when a threshold value for the on-board voltage (V_{B}) has been exceeded,
a switch (SW) with input electrodes (S, G) which can be activated by means of the switching signal (S_{O}) and
a voltage limiter (VL) for limiting short-term overvoltage, characterized in that
the switch (SW) is in series with the electronic unit (EU) before the voltage limiter (VL), and is controlled by the switching signal (S_{O}) of the overvoltage indicator (OVI) via a time integrator (INT),
the time integrator (INT) forms an integration voltage (V_{I}) from the temporal course of the switching signal (S_{O}), which closes the switch (SW) as long as the voltage is within a specified range of values, where the integration voltage (V_{I}) indicates that there is no danger for the electric (sic) unit (EU) and the voltage limiter (VL) from additionally supplied electric power,
the time integrator (INT) opens the switch (SW) to prevent an overheating of the voltage limiter (VL) and/or the electric unit (EU), if the duration and/or the frequency of the exceeded threshold values in the on-board voltage network produce an integration voltage (V_{I}) which lies outside of the specified range of values.

2. A protective circuit as claimed in claim 1, characterized in that, when the switching signal (S_{O}) is missing, the time integrator (INT) keeps the switch (SW) conductive by means of the integration voltage (V_{I}) which is stored as a charging voltage in an integrating capacitor (C_{I}), and
when it exceeds the threshold value of the on-board voltage, the overvoltage indicator (OVI) discharges the integrating capacitor (C_{I}) at a discharge time constant (T_{D}=R6 C_{I}) so that, after a discharging time that is specified by the discharging time constant (T_{D}), the switch (SW) opens by falling below a minimum value of the integration voltage (V_{I}) and separates the electronic unit (EU) from the on-board voltage network.

3. A protective circuit as claimed in claim 2, characterized in that when the switching signal (S_{O}) is missing, the on-board voltage network charges the integrating capacitor (C_{I}) at a charging time constant (T_{C}=(R5+R6) C_{I}), so that for an overvoltage of a predetermined length and low frequency, the integrating capacitor (C_{I}) can supply an integration voltage (V_{I}) that is above the minimum value, and the switch (SW) remains closed.

4. A protective circuit as claimed in claim 1, characterized in that the voltage limiter (VL) is parallel to the operating voltage connections (DC_{OUT}, GND₂) of the electronic unit (EU), and limits the on-board voltage (V_{B}) at the operating voltage connections (DC_{OUT}, GND₂) to a specified limit value when the threshold value is being exceeded, until the switch (SW) separates the electronic unit (EU) from the on-board voltage network.

5. A protective circuit as claimed in claim 4, characterized in that the threshold value of the overvoltage indicator (OVI) lies under the limit value of the voltage limiter (VL).

6. A protective circuit as claimed in claim 1, characterized in that the switch (SW) is an electronic switch which is connected with input electrodes (S, G) via an impedance chain (D2, R5, R6) to a tap (N) at the network connections (DC_{IN}, GND₁), and is kept conductive with the onboard voltage (V_{B}) via this chain.

7. A protective circuit as claimed in claim 1, characterized in that the overvoltage indicator (OVI) is a switching amplifier with at least one amplification stage (V1, V2), with d.c. current branches (I₁, I₂ and I₃) and a signal input, which is connected to one of the network connections (DC_{IN}, GND₁) via a threshold element (D1) with voltage-dependent conductivity, and is designed so that the d.c. current branches (I₁, I₂ and I₃) exclusively conduct cut-off currents of the active components (D1, V1, V2) at an on-board voltage (V_{B}) which lies under the specified threshold value.

8. A protective circuit as claimed in claim 6, characterized in that
the time integrator (INT) comprises the impedance chain (D2, R5, R6) with the tap (N), and the integrating capacitor (C_{I}) which lies parallel to the input electrodes (S, G) of the electronic switch (SW),
when the switching signal (S_{O}) is missing, the impedance chain (D2, R5, R6) charges the integrating capacitor (C_{I}) at the charging time constant (T_{C}=(R5+R6)·C_{I}) with the on-board voltage (V_{B}), and
the overvoltage indicator (OVI) is connected to an output of the tap (N) and discharges the integrating capacitor (C_{I}) at the discharging time constant (T_{C}=(R6·C1) as a function of the duration of the switching signal (S_{O}).

9. A protective circuit as claimed in claim 8, characterized in that the impedance chain (D2, R5, R6) in the time integrator (INT) contains a switching diode (D2) which is polarized so that a discharge of the integrating capacitor (C_{I}) is avoided when the on-board voltage (V_{B}) lies significantly under the normal voltage range.

10. A protective circuit as claimed in claim 1, characterized in that the protective circuit is integrated into the electronic unit (EU) and that the electronic unit (EU) is a telematic unit in an automobile.
